(19) United States
(12) Patent Application Publication
(10) Pub. No.: US 2026/0180780 A1
(43) Pub. Date: Jun. 25, 2026

(54) RADIO DEVICES

(71) Applicant: Nordic Semiconductor ASA, Trondheim (NO)

(72) Inventor: Eivind Sjøgren OLSEN, Trondheim (NO)

(73) Assignee: Nordic Semiconductor ASA, Trondheim (NO)

(21) Appl. No.: 19/422,146

(22) Filed: Dec. 16, 2025

(30) Foreign Application Priority Data
Dec. 19, 2024 (GB) 2418741.1

(51) Int. Cl. H04L 7/04

(52) U.S. Cl. CPC H04L 7/042

(57) ABSTRACT

A method of determining a time of arrival of a packet at a digital radio device is provided. The packet comprises a header portion and a payload portion. The method comprises the digital radio device receiving a radio signal and processing said radio signal to produce an incoming bit sequence, correlating a first section of the incoming bit sequence with a first correlation sequence corresponding to a first section of the packet to determine a first correlation result, correlating a second section of the incoming bit sequence with a second correlation sequence corresponding to a second section of the packet to determine a second correlation result, said second section including at least part of the payload portion, identifying correlation peaks in the first and second correlation results, and determining a time of arrival of the packet at the digital radio device based on said correlation peaks.

### CROSS-REFERENCE TO RELATED APPLICATIONS

This application claims priority from United Kingdom Patent Application No. 2418741.1, filed Dec. 19, 2024, which application is incorporated herein by reference in its entirety.

### BACKGROUND OF THE INVENTION

The present invention relates to digital radio devices and to methods of determining a time of arrival of a packet at such devices.

It is often useful to be able to determine the distance between two radio devices, e.g. to restrict or enable features according to their proximity. This distance determination is commonly referred to as “ranging”.

One method of ranging is called Round-trip timing (RTT). Round-trip timing (RTT) can be used to determine the separation distance between two radio transceivers, even when they do not have access to a common time reference. RTT is based on the measurement of the time for a first timing signal (e.g. a first digital packet for devices which utilise packet-based communications) to travel from a transceiver device A (an “initiator”) to a transceiver device B (a “reflector”) and for a second timing signal (e.g. a second digital packet) to travel from device B back to device A. If the interval from device B receiving the first signal and transmitting the second signal (i.e. the “dwell time” of device B) is known to device A, then device A can calculate the average time of flight (TOF) by subtracting the time of transmission of the first signal (measured according to the clock of device A) plus the dwell time from the time of reception of the second signal (also measured according to the clock of device A), and dividing by two.

This type of ranging relies on each device being able to determine accurately the time at which a timing signal arrives (its Time of Arrival or “ToA”). For devices that use digital packet-based communication protocols, this involves identifying the start of the ranging packet's bit sequence. Often this is done by correlating an incoming bit sequence with a correlation sequence corresponding to the start of an expected ranging packet (sometimes called a “channel sounding” packet), and identifying the timing of a peak in the correlation. This operation is often combined with a correlation operation used to synchronise the receiver with the incoming packet.

For instance, a Bluetooth channel sounding packet typically includes a short preamble followed by an Access Address and then the payload of the packet. The time-of-arrival of such a packet may be determined by a receiver correlating an incoming bit sequence with a correlation sequence corresponding to the preamble and part of the Access Address (AA).

However, not all Access Addresses are well suited to accurate correlation operations and this approach can lead to errors in the determined ToA due to early frame synchronisation (EFS). Moreover, this approach can also be vulnerable to phase or amplitude manipulation attacks, aimed at advancing the apparent ToA calculated by a victim narrowband receiver (e.g. “Early Detect Late Commit” (EDLC) attacks). ToA estimates in digital communication protocols that use frequency shift keying (FSK) modulation such as Bluetooth can also suffer uncertainty due to transmitter imperfections, leading to signal sequence dependent variations in ToA estimates.

One way to mitigate these issues would be to simply extend the length of the bit sequence used by the correlator. However, this increases correlator hardware requirements which may be undesirable. Another approach might be to estimate the time of arrival of several separate packets to produce an average ranging estimate, but this can be slow and is still vulnerable to uncertainties in one or more of the estimated ToAs.

An improved approach may be desired.

### SUMMARY OF THE INVENTION

According to a first aspect of the present invention there is provided a method of determining a time of arrival of a packet at a digital radio device, the packet comprising a header portion and a payload portion, the method comprising:
the digital radio device receiving a radio signal and processing said radio signal to produce an incoming bit sequence;
correlating a first section of the incoming bit sequence with a first correlation sequence corresponding to a first section of the packet to determine a first correlation result;
correlating a second section of the incoming bit sequence with a second correlation sequence corresponding to a second section of the packet to determine a second correlation result, said second section including at least part of the payload portion;
identifying correlation peaks in the first and second correlation results; and
determining a time of arrival of the packet at the digital radio device based on said correlation peaks.

According to a second aspect of the present invention there is provided a digital radio device arranged to:
receive a radio signal and process said radio signal to produce an incoming bit sequence;
correlate a first section of the incoming bit sequence with a first correlation sequence corresponding to a first section of a packet to determine a first correlation result, the packet comprising a header portion and a payload portion;
correlate a second section of the incoming bit sequence with a second correlation sequence corresponding to a second section of the packet to determine a second correlation result, said second section including at least part of the payload portion;
identify correlation peaks in the first and second correlation results; and
determine a time of arrival of the packet at the radio device based on said correlation peaks.

Thus, it will be recognised by those skilled in the art that embodiments of the present invention may enable more accurate and robust determination of packet times of arrival, because different sections of an incoming packet, including at least part of the payload portion, are considered to determine its arrival time. This may reduce uncertainties and vulnerabilities associated with conventional approaches. For instance, phase or amplitude manipulation attacks often rely on advancing an apparent ToA by manipulating only small parts of a packet, to avoid triggering attack detection schemes. Because embodiments of the present invention determine a time of arrival based on multiple sections of a packet, such attacks may no longer be viable.

Moreover, because multiple separate correlations are used (e.g. rather than a single correlation using on a longer section of the bit sequence), excessively capable correlation hardware may not be needed. For instance, existing hardware used for symbol timing synchronisation and/or frequency offset adjustments may be repurposed to perform additional correlations for ToA determination.

A notable improvement in ToA accuracy may be gained from performing only two correlations on different sections of the incoming bit sequence. However, in a set of embodiments a third section of the incoming bit sequence is correlated with a third correlation sequence corresponding to a third section of the packet to determine a third correlation result. Said embodiments may involve identifying a correlation peak in the third correlation result and determining the time of arrival of the packet at the digital radio device using said third correlation peak (i.e. in addition to the first and second correlation peaks). The third section of the packet preferably includes at least part of the payload portion and may include only a part of the payload portion.

This may be repeated with further sections (e.g. fourth, fifth, etc.) to further improve ToA accuracy. In a set of embodiments, at least five sections of the incoming bit sequence (e.g. at least ten or at least fifteen) are correlated with correlation sequences corresponding to respective sections of the packet to determine the time of arrival of the packet.

The length of correlation sequence used may depend on various factors such as the communication protocol being used, a desired ToA accuracy and available correlation hardware. In a set of embodiments, the first correlation sequence may comprise at least 4 bits, at least 8 bits or at least 16 bits. The first correlation sequence may comprise less than 32 bits, less than 24 bits or less than 20 bits. In a set of embodiments, additionally or alternatively, the second correlation sequence may comprise at least 4 bits, at least 8 bits or at least 16 bits and/or less than 32 bits, less than 24 bits or less than 20 bits. Using shorter correlation sequences may reduce the processing resources needed to do the correlations. In a set of embodiments, the first and/or second correlation sequences are between 12 and 24 bits (e.g. 18 bits). The same ranges may apply to any further correlation sequences.

The first and second correlation sequences (and the packet sections to which they correspond) may be of different lengths. However, in a set of embodiments, the first and second correlation sequences (and, in relevant embodiments, any further correlation sequences) have equal lengths. Using only sequences of the same length may simplify ToA estimation and/or enable the re-use of the same correlation hardware for every correlation.

The first and second sections of the packet (to which the first and second correlation sequences correspond) may overlap, i.e. sharing at least one bit. Alternatively, they may be separate with no shared bits (e.g. adjacent to each other or with gaps between them). Similarly, in relevant embodiments, further sections of the packet may overlap with other sections or they may be separate.

In some embodiments involving correlating the incoming bit sequence with three or more correlation sequences, the sections of the packet to which the correlation sequences correspond may be substantially evenly spaced. For instance, there may be an equal or near-equal separation (e.g. within 1-5 bits) between each successive pair of sections of the packet.

In a set of embodiments, the correlation sequences used may collectively correspond to at least 20% of the packet, at least 40% of the packet, at least 60% of the packet, at least 80% of the packet or substantially the entire packet (e.g. 90% or more). For instance, for a 166 bit Bluetooth Channel sounding packet, ten correlations using 18 bit correlation sequences may be used which collectively correspond to all bits in the packet (e.g. with a two bit overlap between some packets).

Correlating a section of the incoming bit sequence with a correlation sequence may, for instance, comprise performing a convolution operation or a cross correlation operation. It will be recognised a correlation result generally comprises a plurality of samples for a corresponding plurality of offsets between the two sequences being correlated. When the offset produces similar sequences, that sample has a large value (e.g. indicating that the section of the bit sequence being considered contains the correlation sequence at that position). A correlation peak may be identified by one more sample values being above a predetermined peak threshold. Additionally or alternatively, other peak detection mechanisms known in the art per se may be used.

In a set of embodiments, the radio device comprises a hardware correlator arranged to perform the correlations. The correlator may have configurable parameters, and the radio device may be arranged to reconfigure the parameters to change the correlation sequence between correlations (i.e. between performing the correlations with the first and second sections). As mentioned above, this approach may be particularly suitable for embodiments in which the first and second (and further) correlation sequences have the same length.

The hardware correlator may also be used for other correlation operations. For instance, in a set of embodiments, the hardware correlator is used to perform symbol timing recovery, carrier frequency offset estimation and/or to establish initial frame timing. In some embodiments, one or more of these operations may be performed using the first correlation result (i.e. without performing a separate correlation operation).

The header portion of the packet may comprise a preamble portion. The header portion of the packet may comprise an address portion (e.g. an Access Address). The header portion of the packet may comprise a trailer portion. The payload portion of the packet may comprise a random or pseudo random bit string. In some embodiments, the payload portion comprises a Sounding Sequence with marker segments at known locations (e.g. mostly comprising a repeating pattern such as 010101 . . . with marker segments such as 0011 or 1100). The packet may comprise a channel sounding packet (e.g. according to a Bluetooth protocol).

As explained above, utilising correlation peaks of multiple correlation results to determine the time of arrival of the packet can reduce uncertainty. In a set of embodiments, this comprises determining a time of arrival estimate from each identified correlation peak, and then averaging these estimates to determine the time of arrival of the packet (e.g. determining a mean of the estimates). Determining the time of arrival estimates may comprise determining a location of the correlation peaks. For instance, determining a first time of arrival estimate may comprise determining a location of the correlation peak in the first correlation result and combining said location with a distance of the first section from a beginning of the packet. The same approach may be applied to produce a second time of arrival estimate (and optionally further time of arrival estimates) from the second correlation result.

Determining the location of a correlation peak may comprise simply identifying the location of a maximum of the correlation result—i.e. a sample in the correlation result having the largest magnitude. This is the closest sample to the “true” offset between the section of the incoming bit sequence and the correlation sequence. Finding the maximum sample may be relatively straightforward to implement. Determining the time of arrival of the packet may comprise applying the following equation:

$${ToA}_{c o a r s e} = \frac{{t}_{clk}}{N} {\sum }_{n = 0}^{N} {T}_{prompt}^{n} \qquad ( 1 )$$

$$where {T}_{prompt}^{n}$$

is the location of the maximum sample in the nth correlation result, N is the total number of correlations performed and tcik is the sample duration (i.e. the sample clock cycle length). The time of arrival estimate may be adjusted to account for an initial synchronization time and any resynchronisations performed.

The applicant has recognised that that, in practice, jitter in a received radio signal means that the actual ToA of a packet is unlikely to align perfectly with the sample timing of the correlation results. It may therefore be desirable to determine a time of arrival estimate more accurately, i.e. at a resolution below that of a demodulator sample rate. In a set of embodiments, determining the location of a correlation peak may comprise fitting an expected peak profile (e.g. a parabola) to at least part of the correlation result and finding a maximum of said peak profile. In other words, determining the location of one or more identified correlation peaks may comprise performing peak interpolation.

For example, determining the (fractional) location of a correlation peak in a correlation result may comprise fitting at least three samples in the correlation result (e.g. a maximum sample and those immediately before and after the maximum sample) to a curve (e.g. a parabolic curve). In some embodiments, determining the location of a correlation peak in a correlation result Tₚₑₐₖ comprises applying the following formula:

$${T}_{peak} = {T}_{prompt} + \frac{E - L}{2 L + 2 E - 4 P} {t}_{clk} , \qquad ( 2 )$$

where Tₚᵣₒₘₚₜ is the location of the maximum sample, E is the value of the correlation sample immediately before the maximum sample (“Early”), P is the value of the maximum sample (“Prompt”) and L is the value of a correlation sample immediately after the maximum sample (“Late”). Tₚₑₐₖ may be considered to represent the “fine” location of a peak, in contrast to the “coarse” location indicated by Tₚᵣₒₘₚₜ.

Using peak interpolation to determine fractional time of arrival estimates based on each correlation result may enable the time of arrival of the packet to be determined more accurately. For instance, the result of equation (2) may be used in place of Tₚᵣₒₘₚₜ in equation (1) to determine the time of arrival more accurately. Finding the precise location of several peaks may also facilitate the detection of invalid packets as explained below.

However, applying even a relatively simple peak finding algorithm such as the EPL approach discussed above to each correlation results can involve considerable data transfer and processing resources.

Therefore, in a set of embodiments, determining a time of arrival of the packet comprises combining the correlation results and determining the time of arrival from a combined correlation result (i.e. without calculating individual time of arrival estimates from each correlation result).

For instance, this may comprise summing sample values from a plurality of correlation results to determine a combined correlation result and determining the time of arrival from this combined correlation result (e.g. by finding a peak in the combined correlation result). Some embodiments may comprise fitting an expected peak profile (e.g. a parabola) to at least part of a combined correlation result. This may comprise fitting at least three samples in the combined correlation result (e.g. a sum of the maximum samples in each correlation result and a sum of those samples immediately before and after the maximum sample in each correlation result) to a parabolic curve and finding a maximum of said peak profile. This may then be used as to determine a fractional correction to the time of arrival of the packet. In other words, determining the time of arrival of the packet may comprise determinising a fractional offset using the following equations:

$${T}_{frac} = \frac{\sum {E}^{n} - \sum {L}^{n}}{2 \sum {L}^{n} + 2 \sum {E}^{n} - 4 \sum {P}^{n}} \qquad ( 3 )$$

$${ToA}_{frac} = {T}_{frac} {t}_{clk} \qquad ( 4 )$$

This may then be used to find the overall time of arrival of the packet:

$${ToA}_{fine} = {ToA}_{coarse} + {ToA}_{frac} \qquad ( 5 )$$

Performing multiple correlations on different sections of an incoming bit sequence may additionally enable convenient detection of invalid packets (e.g. a bit sequence that contains the or part of the first section but not subsequent sections of the packet). Accordingly, in a set of embodiments, the method comprises determining whether a valid packet is present in the incoming bit sequence based on said correlation peaks. The determining a time of arrival of the packet at the digital radio device based on said correlation peaks may only be performed if a valid packet is detected. For instance, if a peak in the second correlation result is at an unexpected location (e.g. outside of an expected window) the bit sequence may be dismissed as not containing a valid packet. Whilst the precise location of a correlation peak in the second correlation result is not be known in advance, an expected window may be determined based on based on a location of the correlation peak in the first correlation result and the separation of the first and second sections in the packet.

The expected window may have a width of a small number of correlation samples (e.g. one or two).

In embodiments which comprise performing one or more further correlations to produce one or more further correlation results (e.g. where a third section of the incoming bit sequence is correlated with a third correlation sequence corresponding to a third section of the packet to determine a third correlation result), the further correlation result(s) may also be used to determine whether a valid packet is present in the incoming bit sequence. For instance, if a peak in one or more further correlation results is at an unexpected location (e.g. based on the location of one or more earlier peaks), the bit sequence may be dismissed as not containing a valid packet. In some embodiments, the bit sequence may only be dismissed as not containing a valid packet if a threshold number of peaks (e.g. two or three or more) are found to be at unexpected locations (e.g. to avoid inadvertently dismissing valid packets).

The use of peak interpolation can aid in detecting invalid packets (e.g. packets which have been tampered with to advance their apparent ToA or legitimate packets with bad combinations of sequences). In a set of embodiments, determining whether a valid packet is present in the incoming bit sequence based on said correlation peaks comprises determining locations of peaks in the first and second correlation results (and potentially further correlation results) using peak interpolation. The bit sequence may be dismissed as invalid if the (fine) location of the peak in the second correlation result is at an unexpected location based on the (fine) location of the peak in the first correlation result and an expected separation. The use of peak interpretation to determine fine locations of peaks may allow for the use of smaller tolerances in the invalid packet detection (e.g. an expected window of less than one correlation sample). In other words, finding a precise peak location for each individual correlation result may enable more precise analysis of deviancy between actual peak locations (relative distances between them) from expected locations. This allows for harsher filtering policies, avoiding bad ToA measurements.

In some embodiments the radio device is arranged to only receive radio signals (i.e. it is a radio receiver device). However, in a set of embodiments, the radio device is also arranged to transmit radio signals. In other words, the radio device may comprise a radio transceiver, i.e. arranged to transmit and receive radio signals. The radio device may comprise various radio transmission components for transmitting radio signals in the common frequency band (e.g. one or more oscillators, amplifiers, mixers, baluns or filters).

The radio device may generally be used for packet-based radio communications in which data is encoded into radio signals in distinct blocks. When the radio device is configured to receive radio signals it may be scanning for incoming packets and/or processing incoming packets.

Processing the radio signal to produce the incoming bit sequence may comprise demodulating and/or decoding the radio signal. For instance, the packet may be encoded in the radio signal using Gaussian Frequency-Shift Keying (GFSK) modulation. Additionally or alternatively, the packet may be encoded in the radio signal using direct-sequence spread spectrum (DSSS).

The radio device may comprise an analogue front-end portion comprising one or more oscillators, filters, mixers, baluns, amplifiers or analogue-to-digital converters (ADCs) for use in converting an analogue radio signal into the incoming bit sequence. The radio device may comprise a digital baseband portion. The radio device may comprise in-phase and quadrature signal paths (i.e. comprising I/Q pairs of one or more components in reception and/or transmission signal paths).

Processing the radio signal to produce the incoming bit sequence may comprise performing one or more preliminary correlation operations, e.g. to aid synchronisation or carrier frequency offset estimation. As explained above, this may utilise the same correlator hardware as that used for ToA estimation.

In a set of embodiments, the radio device is a Bluetooth radio device, i.e. arranged to receive and/or send radio signals according to a Bluetooth protocol (e.g. Bluetooth LE). The radio device may comprise part of an integrated circuit such as a System-on-Chip (SoC).

The invention extends to computer software that, when executed by a digital radio device, causes said digital radio device to perform the method disclosed herein. The radio device may comprise a memory storing said software. The radio device may comprise a processor arranged to execute said software. The invention extends to a non-transitory computer readable medium storing said software.

The applicant considers that performing multiple correlations on different sections of an incoming bit sequence to detect invalid data packets is independently inventive and so according to a third aspect of the present invention there is provided a method of operating a digital radio device arranged to receive packets comprising a header portion and a payload portion, the method comprising:
the digital radio device receiving a radio signal and processing said radio signal to produce an incoming bit sequence;
correlating a first section of the incoming bit sequence with a first correlation sequence corresponding to a first section of the packet to determine a first correlation result;
correlating a second section of the incoming bit sequence with a second correlation sequence corresponding to a second section of the packet to determine a second correlation result, said second section including at least part of the payload portion;
identifying correlation peaks in the first and second correlation results; and
determining whether a valid packet is present in the incoming bit sequence based on said correlation peaks.

According to a second aspect of the present invention there is provided a digital radio device arranged to:
receive a radio signal and process said radio signal to produce an incoming bit sequence;
correlate a first section of the incoming bit sequence with a first correlation sequence corresponding to a first section of a packet to determine a first correlation result, the packet comprising a header portion and a payload portion;
correlate a second section of the incoming bit sequence with a second correlation sequence corresponding to a second section of the packet to determine a second correlation result, said second section including at least part of the payload portion;
identify correlation peaks in the first and second correlation results; and
determine whether a valid packet is present in the incoming bit sequence based on said correlation peaks.

As explained above with reference to the first and second aspects, the determination of whether a valid packet is present may comprise determining whether a correlation peak in the second correlation result is at an unexpected location (e.g. based on a location of the correlation peak in the first correlation result and a separation of the first and second sections in the packet). In embodiments which comprise performing one or more further correlations to produce one or more further correlation results (e.g. where a third section of the incoming bit sequence is correlated with a third correlation sequence corresponding to a third section of the packet to determine a third correlation result), the further correlation result(s) may also be used to determine whether a valid packet is present in the incoming bit sequence. The locations of the peaks used in said determination may be determined using peak interpolation, although this is not essential.

In some embodiments, as explained above with reference to the first and second aspects, if a valid packet is determined to be present in the incoming bit sequence, a time of arrival of the packet at the radio device may then be determined based on the correlation peaks.

Features of any aspect or embodiment described herein may, wherever appropriate, be applied to any other aspect or embodiment described herein. Where reference is made to different embodiments, it should be understood that these are not necessarily distinct but may overlap. It will be appreciated that all of the preferred features of the method according to the first aspect described above may also apply to the other aspects of the invention.

### BRIEF DESCRIPTION OF THE DRAWINGS

One or more non-limiting examples will now be described, by way of example only, and with reference to the accompanying figures in which:

FIG. 1 is a schematic diagram of a radio transceiver device according to an embodiment of the invention;

FIG. 2 is a timing diagram of a packet for use in embodiments of the invention;

FIG. 3 is a flow diagram illustrating an embodiment of the invention; and

FIG. 4 is a schematic diagram illustrating a peak finding approach for use in embodiments of the invention.

### DETAILED DESCRIPTION

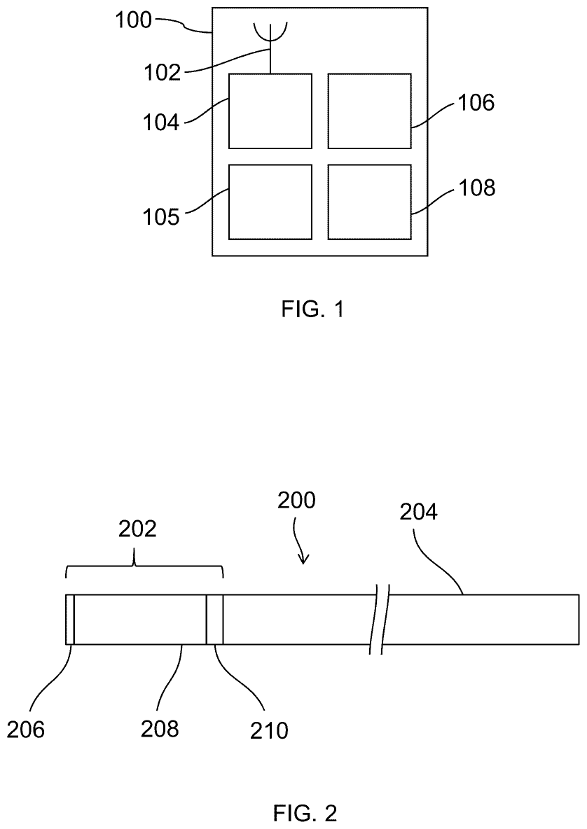

FIG. 1 shows a radio transceiver device 100 comprising an antenna 102, an analogue RF front-end portion 104, a hardware correlator 105, a processor 106 and a memory 108. In this example, the radio transceiver device 100 is a Bluetooth device.

The RF frontend portion 104 handles analogue reception processes such as demodulation, demultiplexing and sampling and may comprise one or more ADCs, mixers, oscillators, filters, amplifiers and/or baluns. The RF frontend portion 104 produces a digital bit stream from an incoming radio signal detected by the antenna 102.

The hardware correlator 105 is a configurable 18-bit correlator which determines correlation results by performing a cross-correlation between a configurable correlation sequence and sections of the incoming bit sequence from the RF frontend portion 104.

The processor 106 executes software stored on the memory 108 to configure the hardware correlator 106 and process its outputs. The memory 108 also stores the bit content of an expected channel sounding packet.

In use, the radio transceiver device 100 listens for a channel sounding packet 200. An example channel sounding packet 200 is shown in FIG. 2. The channel sounding packet 200 comprises a header portion 202 and a payload portion 204. The header portion 202 includes a preamble 206 (2 bits), an access address 208 (32 bits) a trailer 210 (4 bits). In this example, the payload 204 is 128 bits long. The payload 204 may comprise a pseudo-random string of bits, or a sounding pattern of bits. The structure and content of the channel sounding packet 200 is known by the radio transceiver device 100.

The channel sounding packet 200 may be received by the radio transceiver device 100 as part of a Round-Trip timing ranging process, e.g. to determine a distance from the radio transceiver device 100 to the sender of the channel sounding packet. Part of this process relies on the radio transceiver device 100 identifying accurately the time at which the channel sounding packet 200 is received, i.e. its Time of Arrival (ToA).

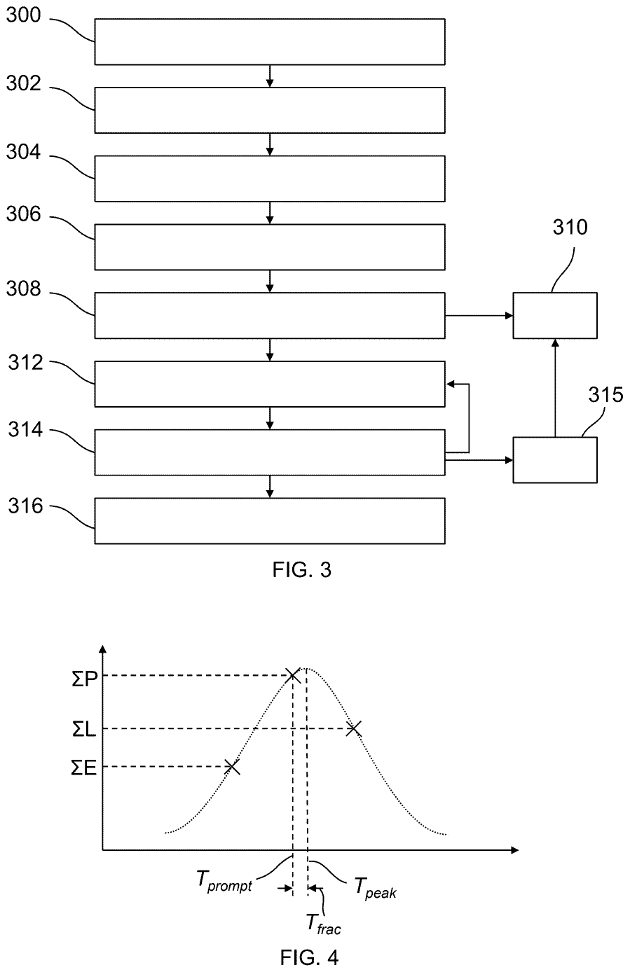

The operation of the radio transceiver device 100 to determine the ToA of the channel sounding packet 200 will now be explained with reference to FIGS. 3 and 4.

In a first step 300, the RF frontend portion 104 processes an incoming radio signal to produce an incoming digital bit sequence.

In step 302, the processor 106 controls the hardware correlator 105 to correlate a first 18 bits of the digital bit sequence with a first correlation sequence. The first correlation sequence is the first 18 bits of an expected channel sounding packet 200 (i.e. the preamble 206 and the first 16 bits of the access address 208).

This operation produces a first correlation result. In step 304, the processor 106 analyses the first correlation result to determine whether it contains a correlation peak. The first correlation result may also be used for synchronising with the incoming radio signal and for carrier frequency offset (CFO) correction.

If a peak is detected, the processor 106 determines the coarse location of the correlation peak by finding the sample of the correlation result having the maximum value (the “prompt” sample).

In step 306, the processor configures the hardware correlator 105 to correlate a second section of the incoming bit stream with a second correlation sequence, producing a second correlation result. The second section of the incoming bit stream is offset by 16 bits (e.g. 8 μs for a 2 Mbps bit rate) from the first section. The second correlation sequence is the last 18 bits of the access address 208.

In step 308, the processor 106 analyses the second correlation result to determine whether it contains a correlation peak and whether the coarse location of that peak is with an acceptable window based on the coarse location of a peak in the first correlation result. The window may be +/−1 bit. If no peak is detected in steps 304 or 308, or if a peak is located in step 308 at an unexpected time based on the peak location in step 304, the processor 106 determines that no valid packet is present in the incoming bit sequence in step 310 and halts further processing. In other examples, steps 304 and 308 may comprise determining a fine location of peaks in the first and second correlation results (e.g. using peak interpolation), and applying a more precise acceptable window to decide whether a valid packet is present in the incoming bit sequence in step 310.

If peaks are identified within the acceptable window (i.e. if a valid packet is detected), the processor continues to step 312 in which the processor 106 configures the hardware correlator 105 to correlate a third section of the incoming bit stream with a third correlation sequence, producing a third correlation result. A correlation peak is identified and located for this correlation result in step 314 (if one is present). The third correlation sequence is the four bits of the trailer 210 and the first 14 bits of the payload 204.

Steps 312 and 314 then repeat for seven further sections and corresponding correlation sequences, to produce seven further correlation results containing up to seven further peaks.

For each correlation peak that is detected in step 314, the processor determines in step 315 whether it is located in an acceptable window based on the location of previously detected peaks (e.g. based on fine or coarse peak locations). If a threshold number of peaks (e.g. two peaks) are found to be at unexpected locations, the processor 106 may determine in step 310 that no valid packet is present in the incoming bit sequence and halt further processing.

These correlation results are then processed in step 316 to determine the time of arrival of the packet.

Step 316 comprises first determining a coarse estimate of the time of arrival of the packet ToA_{coarse}. This involves identifying the offset of the maximum sample in each correlation result continuing a correlation peak (i.e. the location of prompt samples Tₚᵣₒₘₚₜ). These locations are averaged and multiplied by the sample clock cycle time (i.e. using equation (1)) to find the coarse estimate of the time of arrival of the packet. This time of arrival is relative to the start of the first section of the bit sequence, and this may then be combined with a known initial synchronisation time and compensated for any resynchronisations to find the actual time of arrival.

Due to jitter, the precise time of arrival of the packet is unlikely to align perfectly with the sample timing of the radio device 100, the processor 106 then determines a fine estimate of the of the time of arrival of the packet ToA_{fine} by combining the coarse estimate with a fractional timing offset. The fractional offset is determined by determining three sums: a “prompt” sum ΣPⁿ of the maximum sample values of the correlation results, and “early” sum ΣEⁿ of the values of the samples immediately before the maximums, and a “late” sum ΣLⁿ of the values of the samples immediately after the maximums. These sums represent a combined correlation result, i.e. describing an aggregate peak shape across the correlation results. The processor 106 fits a parabola to this shape using the formula of equation (3) to determine a fractional offset T_{frac of} the “true” peak location Tₚₑₐₖ from the prompt peak location Tₚᵣₒₘₚₜ. This peak finding operation is illustrated schematically in FIG. 4.

The fractional offset T_{frac} is then combined with the sample clock timing to produce a fractional offset to the time of arrival estimate ToA_{fract} (i.e. using equation 4), and then this is combined with the coarse time of arrival ToA_{coarse} to determine the fine estimate of the of the time of arrival of the packet ToA_{fine} (i.e. using equation 5). Because the peak finding algorithm is applied only once to the summed values, this approach may be quicker and/or more efficient than finding a precise peak location for each individual correlation result and then averaging these.

The approach described herein of using multiple correlation results (i.e. multiple “pings”) can improve the accuracy with which the time of arrival of a digital radio packet can be estimated. For instance, Table 1 below shows the performance of the multiple-ping approach disclosed herein when determining the times of arrival of a series of Bluetooth channel sounding packets transmitted using different Bandwidth-time products BT and modulation indices h. It can be seen that the mean ToA bias when only one ping is used (i.e. when multiple correlations are not performed on a single packet) can be as high as ±1.3 ns for some values of h and BT. When two pings are used, this is improved to a maximum of 1 ns and when ten pings are used, to only 0.7 ns.

TABLE 1
Mean offset for BT and Mod Index (h) variations

| | 1 ping | | | | 2 pings | | | 10 pings | | |
|---|---|---|---|---|---|---|---|---|---|---|
| | Bias mean (ns) | | | | | | | | | |
| | BT | | | | BT | | | BT | | |
| | | 0.4 | 0.5 | 0.6 | 0.4 | 0.5 | 0.6 | 0.4 | 0.5 | 0.6 |
| h | 0.45 | 1.2 | 1.2 | 1.3 | 0.6 | 0.7 | 1.0 | 0.7 | 0.7 | 0.7 |
| | 0.5 | 0.1 | 0 | 0.2 | −0.4 | 0 | 0.2 | −0.5 | 0 | 0.2 |
| | 0.55 | −1.3 | −0.7 | −0.7 | −0.5 | −0.5 | −0.3 | −0.2 | −0.2 | −0.2 |

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are within the spirit and scope of the disclosure. Additionally, while various embodiments of the invention have been described, it is to be understood that aspects of the invention may include only some of the described embodiments. Accordingly, the invention is not to be seen as limited by the foregoing description.

1. A method of determining a time of arrival of a packet at a digital radio device, the packet comprising a header portion and a payload portion, the method comprising:
the digital radio device receiving a radio signal and processing said radio signal to produce an incoming bit sequence;
correlating a first section of the incoming bit sequence with a first correlation sequence corresponding to a first section of the packet to determine a first correlation result;
correlating a second section of the incoming bit sequence with a second correlation sequence corresponding to a second section of the packet to determine a second correlation result, said second section including at least part of the payload portion;
identifying correlation peaks in the first and second correlation results; and
determining a time of arrival of the packet at the digital radio device based on said correlation peaks.

2. The method of claim 1, further comprising:
correlating a third section of the incoming bit sequence with a third correlation sequence corresponding to a third section of the packet to determine a third correlation result;
identifying a correlation peak in the third correlation result; and
determining the time of arrival of the packet at the digital radio device using said third correlation peak.

3. The method of claim 2, comprising correlating at least five sections of the incoming bit sequence with correlation sequences corresponding to respective sections of the packet to determine the time of arrival of the packet.

4. The method of claim 1, wherein the first correlation sequence comprises at least 4 bits and less than 32 bits.

5. The method of claim 1, wherein the first and second correlation sequences have equal lengths.

6. The method of claim 1, wherein the first and second correlation sequences overlap.

7. The method of claim 1, comprising performing correlations with correlation sequences that collectively correspond to at least 20% of the packet.

8. The method of claim 1, wherein the digital radio device comprises a hardware correlator that performs the correlations.

9. The method of claim 1, comprising determining a time of arrival estimate from each identified correlation peak, and then averaging the time of arrival estimate estimates to determine the time of arrival of the packet.

10. The method of claim 1, comprising performing peak interpolation to determine a location of one or more identified correlation peaks.

11. The method of claim 1, wherein determining the time of arrival of the packet comprises combining the correlation results and determining the time of arrival from a combination of the correlation results.

12. The method of claim 11, comprising fitting an expected peak profile to at least part of the combined correlation result.

13. The method of claim 1, comprising determining whether a valid packet is present in the incoming bit sequence based on said correlation peaks and determining a time of arrival of the packet at the digital radio device based on said correlation peaks in response to determining that a valid packet is detected.

14. A non-transitory computer-readable medium storing software instructions that, when executed by a digital radio device, cause said digital radio device to perform the method of claim 1.

15. A digital radio device, wherein the digital radio device comprises an analog front-end portion and a digital baseband portion, and wherein the digital radio device is configured to:
receive a radio signal and process said radio signal to produce an incoming bit sequence;
correlate a first section of the incoming bit sequence with a first correlation sequence corresponding to a first section of a packet to determine a first correlation result, the packet comprising a header portion and a payload portion;
correlate a second section of the incoming bit sequence with a second correlation sequence corresponding to a second section of the packet to determine a second correlation result, said second section including at least part of the payload portion;
identify correlation peaks in the first and second correlation results; and
determine a time of arrival of the packet at the digital radio device based on said correlation peaks.

16. The digital radio device of claim 15, wherein the digital radio device is a Bluetooth radio device.

17. A method of operating a digital radio device configured to receive packets comprising a header portion and a payload portion, the method comprising:
the digital radio device receiving a radio signal and processing said radio signal to produce an incoming bit sequence;
correlating a first section of the incoming bit sequence with a first correlation sequence corresponding to a first section of the packet to determine a first correlation result;
correlating a second section of the incoming bit sequence with a second correlation sequence corresponding to a second section of the packet to determine a second correlation result, said second section including at least part of the payload portion;
identifying correlation peaks in the first and second correlation results; and
determining whether a valid packet is present in the incoming bit sequence based on said correlation peaks.

18. The method of claim 17, further comprising, when a valid packet is determined to be present in the incoming bit sequence, determining a time of arrival of the packet at the digital radio device based on the correlation peaks.
